(19) United States
(12) Patent Application Publication
(10) Pub. No.: US 2026/0148169 A1
(43) Pub. Date: May 28, 2026

(54) METHOD AND SYSTEM FOR ASSESSING SECURITY RISK

(71) Applicant: JPMorgan Chase Bank, N.A., New York, NY (US)

(72) Inventors: Rohit TALREJA, Hyderabad (IN); Kevin J. MCNAMARA, Newfoundland, NJ (US); Elizabeth PARK, Frisco, TX (US); Mario MACIAS, Plano, TX (US); Bhavani ELURU, Bangalore (IN); Dejan SAVIC, Burleson, TX (US); Preeti GUPTA, Plano, TX (US); Gretchen WRIGHT-WILLIAMS, Sunbury, OH (US); Brian SORENSEN, Conroe, TX (US); Scott QUINLIN, Montgomery, TX (US); Gabriel CASSINI, Dublin, OH (US); Jeremiah C. OLVER, Middletown, DE (US)

(73) Assignee: JPMorgan Chase Bank, N.A., New York, NY (US)

(21) Appl. No.: 19/028,867

(22) Filed: Jan. 17, 2025

(30) Foreign Application Priority Data
Nov. 27, 2024 (IN) 202411092626

(51) Int. Cl. G06Q 10/0635; G06F 40/30; G10L 25/69

(52) U.S. Cl. CPC G06Q 10/0635; G06F 40/30; G10L 25/69

(57) ABSTRACT

A method and a system for assessing a likelihood of a security risk are provided. The method includes: receiving first information that relates to a communication between a representative of an entity and a customer; determining, from the first information, at least one communication attribute; determining, based on the at least one communication attribute, a first risk score that relates to the customer; and determining, based on the at least one communication attribute, a second risk score that relates to the representative. The at least one communication attribute is based on at least one from among a content of the communication, a tone of voice used in the communication, language used in the communication, a behavioral pattern of the customer, and a behavioral pattern of the representative. Each of the first risk score and the second risk score relates to a probability of a potential security threat to the entity

### CROSS-REFERENCE TO RELATED APPLICATIONS

This application claims priority benefit from Indian Application No. 202411092626, filed on Nov. 27, 2024, in the India Patent Office, which is hereby incorporated by reference in its entirety.

### BACKGROUND

### 1. Field of the Disclosure

This technology generally relates to methods and systems for assessing a likelihood of a security risk, and more particularly to methods and systems for analyzing communications to determine a probability of a potential security threat to an entity and automatically generating responses to reduce the potential security threat.

### 2. Background Information

Customer assist channels (e.g., call centers, email responses, digital assistants, SMS support, etc.) are an essential part of many organizations, providing support to customers who need assistance with their products or services. However, they are also a prime target for social engineering attacks, where attackers use various tactics to trick call center agents into divulging sensitive information or performing unauthorized actions. These attacks include vishing (voice phishing), where attackers use a phone call to impersonate a legitimate caller and extract information, phishing (email-based attacks), smishing (SMS-based attacks), and voice altering attacks, where attackers use technology to modify their voice and impersonate someone else.

Traditional methods of detecting and preventing these attacks are often inadequate, relying on manual processes and rule-based systems that are easily bypassed by attackers. This leaves call centers vulnerable to attacks, which can result in significant financial and reputational damage.

Traditional methods used by call center agents to detect and prevent these threats include: Security Awareness Training: call center agents receive training on how to identify and report suspicious activities; Call Monitoring: supervisors listen to calls and identify any suspicious activities or behavior; Identity Verification: agents ask callers for personal information to verify their identity; Authentication: agents use authentication tools to verify the identity of the caller; Access Controls: agents use access controls to restrict access to sensitive information. However, these methods have limitations. Human error can result in missed threats, lack of accuracy can lead to false positives and negatives, and these methods may not keep up with evolving threats. As a result, call centers need to adopt new cybersecurity solutions to detect and prevent threats.

Accordingly, there is a need for analyzing communications to determine a probability of a potential security threat to an entity and automatically generate responses to reduce the potential security threat.

### SUMMARY

The present disclosure, through one or more of its various aspects, embodiments, and/or specific features or sub-components, provides, inter alia, various systems, servers, devices, methods, media, programs, and platforms for analyzing communications to determine a probability of a potential security threat to an entity and automatically generating responses to reduce the potential security threat. According to an aspect of the present disclosure, a method for assessing a likelihood of a security risk is provided. The method may be implemented by at least one processor. The method may include: receiving, by the at least one processor, first information that relates to a communication between a representative of an entity and a customer; determining, by the at least one processor from the first information, at least one communication attribute that is based on at least one from among a content of the communication, a tone of voice used in the communication, language used in the communication, a behavioral pattern of the customer in the communication, and a behavioral pattern of the representative in the communication; determining, by the at least one processor based on the at least one communication attribute, a first risk score that relates to the customer; and determining, by the at least one processor based on the at least one communication attribute, a second risk score that relates to the representative. Each of the first risk score and the second risk score may relate to a probability of a potential security threat to the entity.

The method may further include generating, by the at least one processor based on the analyzing of the first information, suggestions for at least one response to be provided to the customer. The analyzing of the first information may include at least one from among a point in time assessment, a real-time assessment, and a continuous assessment of the at least one communication attribute.

The method may further include flagging the communication as a potential threat when at least one from among the first risk score and the second risk score exceeds a predetermined threshold score; generating, by the at least one processor based on the flagging of the communication and the analyzing of the first information, a current risk status and a recommendation for at least one next action; and transmitting, by the at least one processor, the current risk status and the recommendation to the representative.

The analyzing of the first information may include applying a natural language processing (NLP) model to identify a context and an intent of the communication.

The communication may include a telephone call and the analyzing of the first information may include applying a machine learning (ML) algorithm that performs at least one from among identifying at least one from among a pattern and an anomaly in the telephone call and detecting a use of a voice altering technology. The ML algorithm may be trained using enterprise risk guidelines, and the ML algorithm may apply the enterprise risk guidelines for the assessing of the at least one communication attribute.

The method may further include: collecting at least one from among call recordings, call center logs, voice recordings, customer feedback, chat logs, and social media feeds; and training, based on the collecting, the ML algorithm to detect conversational patterns and conversational anomalies that are usable for determining at least one from among the first risk score and the second risk score.

The method may further include, when at least one from among the first risk score and the second risk score exceeds a predetermined threshold, performing at least one from among: generating, by the at least one processor, a replica of a voice of the representative and automatically responding to the customer via the generated replica; terminating, by the at least one processor, the communication; and generating, by the at least one processor, an automated warning to contact a leadership group of the representative for real-time intervention.

The method may further include: analyzing, by the at least one processor, first screening data that relates to the customer, wherein the first screening data includes at least one from among a caller identification assessment of the customer, a telephone number assessment of the customer, and a voice assessment of the customer; assigning, by the at least one processor based on the analyzing of the first screening data, a first screening score to the customer; and matching, by the at least one processor based on the first screening score, the customer to a corresponding entity representative selected from among a plurality of entity representatives.

The method may further include transmitting, by the at least one processor, the first information, the first risk score, and the second risk score to a security entity for at least one from among a security investigation and a risk remediation. The potential security threat to the entity may include at least one from among a social engineering type threat, a voice phishing type threat, a phishing type threat, a short message service (SMS) phishing type threat, and a voice altering attack type threat.

According to another aspect of the present disclosure, a computing apparatus for assessing a likelihood of a security risk is provided. The computing apparatus includes a processor; a memory; a display; and a communication interface coupled to each of the processor, the memory, and the display. The processor may be configured to: receive first information that relates to a communication between a representative of an entity and a customer; determine, from the first information, at least one communication attribute that is based on at least one from among a content of the communication, a tone of voice used in the communication, language used in the communication, a behavioral pattern of the customer in the communication, and a behavioral pattern of the representative in the communication; determine, based on the at least one communication attribute, a first risk score that relates to the customer; and determine, based on the at least one communication attribute, a second risk score that relates to the representative. Each of the first risk score and the second risk score may relate to a probability of a potential security threat to the entity.

The processor may be further configured to: generate, based on the analysis of the first information, suggestions for at least one response to be provided to the customer. The analysis of the first information may include at least one from among a point in time assessment, a real-time assessment, and a continuous assessment of the at least one communication attribute.

The processor may be further configured to flag the communication as a potential threat when at least one from among the first risk score and the second risk score exceeds a predetermined threshold score; generate, based on the flagging of the communication and the analysis of the first information, a current risk status and a recommendation for at least one next action; and transmit the current risk status and the recommendation to the representative.

The processor may be further configured to apply an NLP model to identify a context and an intent of the communication.

The communication may include a telephone call and the processor may be further configured to apply an ML algorithm that performs at least one from among identifying at least one from among a pattern and an anomaly in the telephone call and detecting a use of a voice altering technology. The ML algorithm may be trained using enterprise risk guidelines. The ML algorithm may apply the enterprise risk guidelines for the assessing of the at least one communication attribute.

The processor may be further configured to: collect at least one from among call recordings, call center logs, voice recordings, customer feedback, chat logs, and social media feeds; and train, based on the collection, the ML algorithm to detect conversational patterns and conversational anomalies that are usable for determining at least one from among the first risk score and the second risk score.

The processor may be further configured to, when at least one from among the first risk score and the second risk score exceeds a predetermined threshold, perform at least one from among: generate a replica of a voice of the representative and automatically respond to the customer via the generated replica; terminate the communication; and generate an automated warning to contact a leadership group of the representative for real-time intervention.

The processor may be further configured to: analyze first screening data that relates to the customer; assign, based on the analysis of the first screening data, a first screening score to the customer; and match, based on the first screening score, the customer to a corresponding entity representative selected from among a plurality of entity representatives. The first screening data may include at least one from among a caller identification assessment of the customer, a telephone number assessment of the customer, and a voice assessment of the customer.

The processor may be further configured to transmit the first information, the first risk score, and the second risk score to a security entity for at least one from among a security investigation and a risk remediation. The potential security threat to the entity may include at least one from among a social engineering type threat, a voice phishing type threat, a phishing type threat, a SMS phishing type threat, and a voice altering attack type threat.

According to yet another aspect of the present disclosure, a non-transitory computer readable storage medium storing instructions for assessing a likelihood of a security risk is provided. The storage medium includes executable code which, when executed by a processor, may cause the processor to: receive first information that relates to a communication between a representative of an entity and a customer; determine, from the first information, at least one communication attribute that is based on at least one from among a content of the communication, a tone of voice used in the communication, language used in the communication, a behavioral pattern of the customer in the communication, and a behavioral pattern of the representative in the communication; determine, based on the at least one communication attribute, a first risk score that relates to the customer; and determine, based on the at least one communication attribute, a second risk score that relates to the representative. Each of the first risk score and the second risk score relates to a probability of a potential security threat to the entity.

The executable code may further cause the processor to generate, based on the analysis of the first information, suggestions for at least one response to be provided to the customer. The analysis of the first information may include at least one from among a point in time assessment, a real-time assessment, and a continuous assessment of the at least one communication attribute.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for analyzing communications to determine a probability of a potential security threat to an entity and automatically generating responses to reduce the potential security threat, according to an embodiment.

FIG. 2 illustrates a diagram of a network environment for analyzing communications to determine a probability of a potential security threat to an entity and automatically generating responses to reduce the potential security threat, according to an embodiment.

FIG. 3 illustrates a system diagram of a system for analyzing communications to determine a probability of a potential security threat to an entity and automatically generating responses to reduce the potential security threat, according to an embodiment.

FIG. 4 illustrates a process diagram of a process for analyzing communications to determine a probability of a potential security threat to an entity and automatically generating responses to reduce the potential security threat, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units and/or modules of the example embodiments may be physically combined into more complex blocks, units, and/or modules without departing from the scope of the present disclosure.

A system or method disclosed herein assesses communication channels for determining the likelihood of a potential security risk. Particularly, the system receives information related to a telephone call, a text message, a social media post, an email, an online voice tool message, and an online chat tool message between a customer and a company representative. The system uses NLP and/or ML to analyze the communication attributes (e.g., content of the communication, a tone of voice used in the communication, language used in the communication, a behavioral pattern of the customer, and a behavioral pattern of the representative) from this received information. The system then determines a risk score associated with the customer and a risk score associated with the representative based on this analysis. Then, the system determines the overall probability of a potential security threat based on the risk scores and generates corresponding corrective actions and/or prompts to try and prevent any negative or harmful events/attacks.

By utilizing NLP and/or ML to assess communications and identify potential security risks, the system provides better security threat protection by not only identifying potential security risks but by also generating preemptive actions to prevent any potential harm or risks from occurring. Particularly, the system prevents threats from being missed, improves the accuracy of detection, and adapts to evolving threats. Additionally, the system may provide a technical improvement by integrating into existing customer response systems to analyze communications in real-time, identify potential threats, and perform corrective actions necessary to eliminate the threat. Thus, the system provides call centers with a cybersecurity solution that is able to detect and prevent threats.

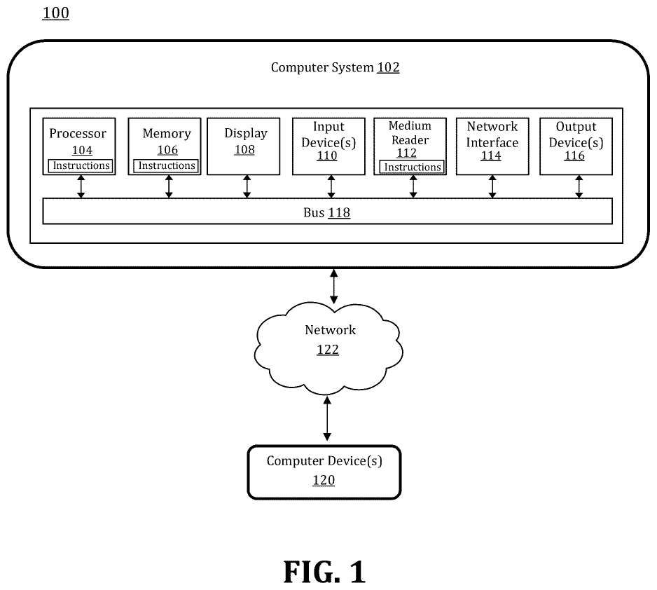

FIG. 1 is a system 100 for analyzing communications to determine a probability of a potential security threat to an entity and automatically generating responses to reduce the potential security threat, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the security risk analysis module implemented by the system 100 may allow for analyzing communications to determine a probability of a potential security threat to an entity and automatically generating responses to reduce the potential security threat. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

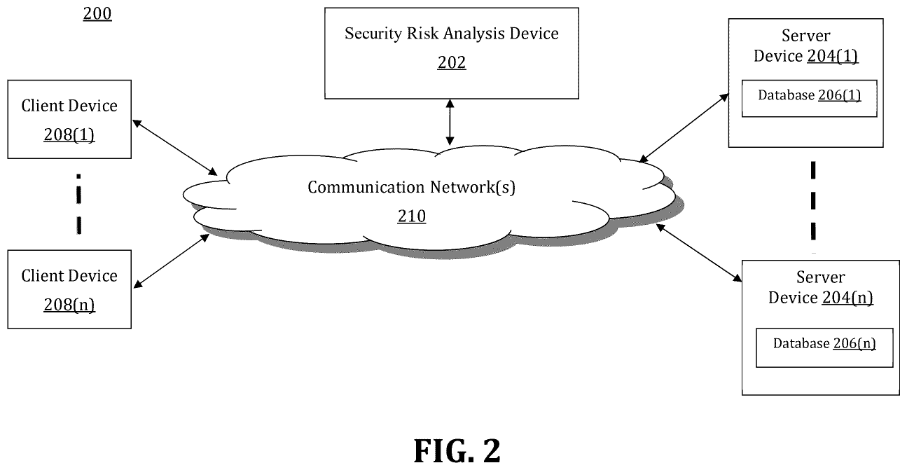

Referring to FIG. 2, a schematic of a network environment 200 for analyzing communications to determine a probability of a potential security threat to an entity and automatically generating responses to reduce the potential security threat is illustrated.

In some embodiments, the above-described problems associated with conventional tools may be overcome by implementing a security risk analysis device 202 as illustrated in FIG. 2 that may be configured for analyzing communications to determine a probability of a potential security threat to an entity and automatically generating responses to reduce the potential security threat, but the disclosure is not limited thereto.

The security risk analysis device 202 may include one or more computer systems 102, as described with respect to FIG. 1, which in aggregate provide the necessary functions.

The security risk analysis device 202 may store one or more applications that can include executable instructions that, when executed by the security risk analysis device 202, cause the security risk analysis device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the security risk analysis device 202 itself, may be located in virtual server(s) running in a cloud-based computing environment rather than being tied to one or more specific physical network computing devices. Also, the application(s) may be running in one or more virtual machines (VMs) executing on the security risk analysis device 202. Additionally, in one or more embodiments of this technology, virtual machine(s) running on the security risk analysis device 202 may be managed or supervised by a hypervisor.

In the network environment 200 of FIG. 2, the security risk analysis device 202 may be coupled to a plurality of server devices 204(1)-204(n) that hosts a plurality of databases 206(1)-206(n), and also to a plurality of client devices 208(1)-208(n) via communication network(s) 210. A communication interface of the security risk analysis device 202, such as the network interface 114 of the computer system 102 of FIG. 1, operatively couples and communicates between the security risk analysis device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the security risk analysis device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The security risk analysis device 202 may be a standalone device or integrated with one or more other devices or apparatuses, such as one or more of the server devices 204(1)-204(n), for example. In one example, the security risk analysis device 202 may be hosted by one of the server devices 204(1)-204(n), and other arrangements are also possible. Moreover, one or more of the devices of the security risk analysis device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the security risk analysis device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the security risk analysis device 202 that may efficiently provide a platform for analyzing communications to determine a probability of a potential security threat to an entity and automatically generating responses to reduce the potential security threat, but the disclosure is not limited thereto.

The client devices 208(1)-208(n) may run interface applications, such as standard web browsers or standalone client applications, which may provide an interface to communicate with the security risk analysis device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the security risk analysis device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the security risk analysis device 202, the server devices 204(1)-204(n), or the client devices 208(1)-208(n), for example, may be configured to operate as virtual instances on the same physical machine. For example, one or more of the security risk analysis devices 202, the server devices 204(1)-204(n), or the client devices 208(1)-208(n) may operate on the same physical device rather than as separate devices communicating through communication network(s) 210. Additionally, there may be more or fewer security risk analysis devices 202, server devices 204(1)-204(n), or client devices 208(1)-208(n) than illustrated in FIG. 2. In some embodiments, the security risk analysis device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

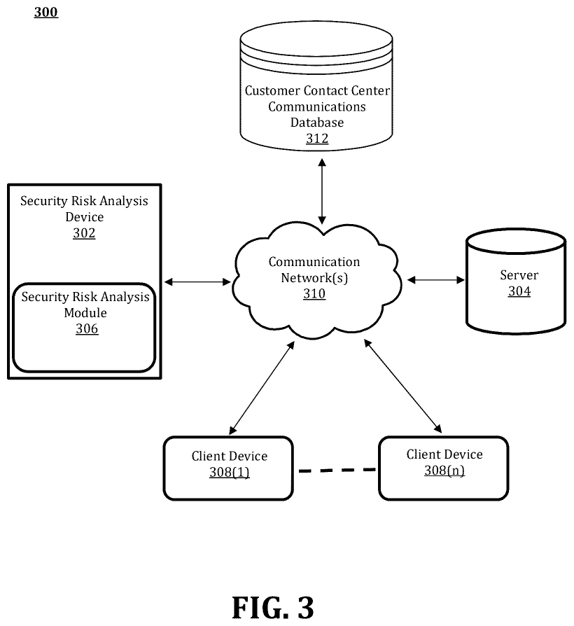

FIG. 3 illustrates a system diagram for analyzing communications to determine a probability of a potential security threat to an entity and automatically generating responses to reduce the potential security threat in accordance with an embodiment.

As illustrated in FIG. 3, the system 300 may include a security risk analysis device 302 within which a security risk analysis module 306 is embedded, a server 304, a customer contact center communications database 312, a plurality of client devices 308(1) . . . 308(n), and a communication network 310.

In some embodiments, the security risk analysis device 302 including the security risk analysis module 306 may be connected to the server 304, and the customer contact center communications database 312 via the communication network 310. The security risk analysis device 302 may also be connected to the plurality of client devices 308(1) . . . 308(n) via the communication network 310, but the disclosure is not limited thereto. The customer contact center communications database 312 may include one or more repositories or databases.

In an embodiment, the security risk analysis device 302 is described and shown in FIG. 3 as including the security risk analysis module 306, although it may include other rules, policies, modules, databases, or applications, for example. In some embodiments, the customer contact center communications database 312 may be configured to store ready to use modules written for each Application Programming Interface (API) for all environments. Although only one database is illustrated in FIG. 3, the disclosure is not limited thereto. Any number of desired databases and/or repositories may be utilized for use in the disclosed invention herein. The customer contact center communications database 312 may be a mainframe database, a log database that may produce programming for searching, monitoring, and analyzing machine-generated data via a web interface, but the disclosure is not limited thereto. In addition, the customer contact center communications database 312 may store a plurality of communications for training ML algorithms.

In some embodiments, the security risk analysis module 306 may be configured to receive real-time feed of data from the plurality of client devices 308(1) . . . 308(n) and secondary sources via the communication network 310.

The security risk analysis module 306 may be configured to: receive first information that relates to a communication between a representative of an entity and a customer, wherein the communication includes at least one from among a telephone call, at least one text message, at least one social media post, at least one email, an online voice tool message, and an online chat tool message; analyze the first information to assess at least one communication attribute, wherein the at least one communication attribute includes at least one from among a content of the communication, a tone of voice used in the communication, language used in the communication, a behavioral pattern of the customer, and a behavioral pattern of the representative; determine, based on a result of the analysis, a first risk score that relates to the customer; and determine, based on the result of the analysis, a second risk score that relates to the representative, wherein each of the first risk score and the second risk score relates to a probability of a potential security threat to the entity.

The plurality of client devices 308(1) . . . 308(n) are illustrated as being in communication with the security risk analysis device 302. In this regard, the plurality of client devices 308(1) . . . 308(n) may be “clients” (e.g., customers) of the security risk analysis device 302 and are described herein as such. Nevertheless, it is to be known and understood that the plurality of client devices 308(1) . . . 308(n) need not necessarily be “clients” of the security risk analysis device 302, or any entity described in association therewith herein. Any additional or alternative relationship may exist between either or both plurality of client devices 308(1) . . . 308(n) and the security risk analysis device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) . . . 308(n) may communicate with the security risk analysis device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The security risk analysis device 302 may be the same or similar to the security risk analysis device 202 as described with respect to FIG. 2, including any features or combination of features described with respect thereto.

Upon being started, the security risk analysis device 302 executes a process for analyzing communications to determine a probability of a potential security threat to an entity and automatically generating responses to reduce the potential security threat.

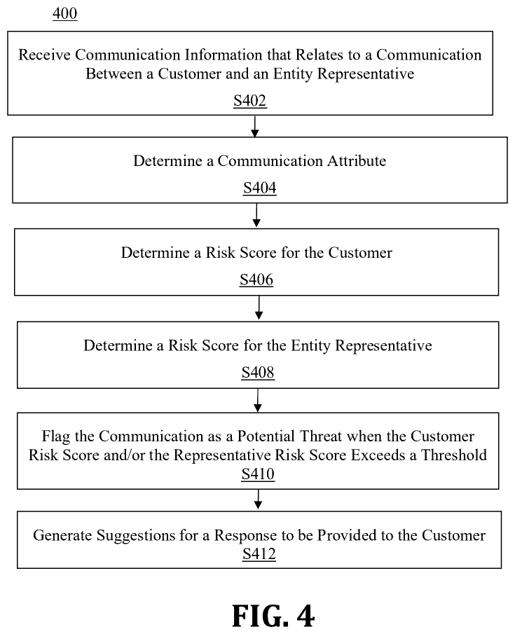

Referring to FIG. 4, a process 400 for analyzing communications to determine a probability of a potential security threat to an entity and automatically generating responses to reduce the potential security threat is illustrated, according to an embodiment.

In process 400 of FIG. 4, at step S402, the security risk analysis device 302 may receive information that relates to a communication between a representative of an entity and a customer. In some embodiments, the communication may include at least one from among a telephone call, text messages, social media posts, emails, online voice tool messages, and online chat tool messages. In an embodiment, prior to assigning an entity representative, the security risk analysis device 302 may analyze screening data that relates to the customer and information about the initial communication to assign a screening score to the customer. The screening data may include at least one from among a caller identification assessment of the customer, a telephone number assessment of the customer, and a voice assessment of the customer. The security risk analysis device 302 may then match the customer to a corresponding entity representative based on the assigned screening score.

At step S404, the security risk analysis device 302 may determine at least one communication attribute from the communication between the representative and the customer. In some embodiments, the at least one communication attribute may be based on at least one from among a content of the communication, a tone of voice used in the communication, language used in the communication, a behavioral pattern of the customer, and a behavioral pattern of the representative. In an embodiment, an NLP model may be used to identify at least one from among the context and the intent of the communication. In some embodiments, a ML algorithm may be used to identify at least one from among a pattern and an anomaly in the communication. The ML algorithm may also be used to detect a use of a voice altering technology. In an embodiment, the security risk analysis device 302 may collect at least one from among call recordings, call center logs, voice recordings, customer feedback, chat logs, and social media feeds to train the ML algorithm. The ML algorithm may be trained to detect conversational patterns and conversational anomalies for analysis. For example, the ML algorithm may identify suspicious keywords or phrases that indicate a potential threat (e.g., a phishing attempt). Additionally, the ML algorithm may be able to detect anomalies that occur during the communication. For example, ML algorithm may be able to detect if a call center agent starts accessing sensitive customer information without legitimate reasoning and may flag the activity to alert to security personnel. The determining of the communication attributes may be point in time assessments, in which the communication is analyzed at a particular moment in time. The determining of the communication attributes may be done continuously, in which the entire communication is analyzed from start to finish. The determining of the communication attributes may be done in real-time.

At step S406, the security risk analysis device 302 may determine a risk score that relates to the customer based on the content of the customer's communication. For example, the security risk analysis device 302 may identify suspicious keywords or phrases that may indicate a potential threat (e.g., a phishing attempt). The amount and type of suspicious keywords identified may be reflective of the determined risk score. For example, a customer communication that include a high number of suspicious keywords representative of someone trying to obtain sensitive information would have a relatively high (e.g., >5) risk score. In an embodiment, the risk score may relate to a probability of a potential security threat to the entity. In some embodiments, the ML algorithm may be trained to detect conversational patterns and conversational anomalies, which may be used to determine the customer's risk score. In some embodiments, the risk score may be selected to be a number from one to ten. A risk score having a number selected between one and five may be designated as an amber threat level. And a risk score having a number selected between six and ten may be designated as a red threat level. In an embodiment, the potential security threat may include at least one from among a social engineering type threat, a voice phishing type threat, a phishing type threat, a SMS phishing type threat, and a voice altering attack type threat. In some embodiments, the ML algorithm may be trained using enterprise risk guidelines, such that the assessment and the suggestions generated by the security risk analysis device 302 may be based on the appropriate enterprise risk guidelines.

At step S408, the security risk analysis device 302 may determine a risk score that relates to the entity representative based on the content of the entity representative's communication, as well as the actions performed by the entity representative during the communication. For example, the security risk analysis device 302 may identify suspicious keywords or phrases, as well suspicious actions (e.g., accessing of sensitive information without legitimate reasoning), that may indicate a potential threat (e.g., a phishing attempt). The amount and type of suspicious keywords and actions identified may be reflective of the determined risk score. For example, an entity representative communication that include a high number of suspicious keywords and actions representative of someone trying to obtain sensitive information would have a relatively high (e.g., >5) risk score. In an embodiment, the risk score may relate to a probability of a potential security threat to the entity. In some embodiments, the ML algorithm may be trained to detect conversational patterns and conversational anomalies, which may be used to determine the entity representative's risk score. In some embodiments, the risk score may be selected to be a number from one to ten. A risk score having a number selected between one and five may be designated as an amber threat level. And a risk score having a number selected between six and ten may be designated as a red threat level. In an embodiment, the potential security threat may include at least one from among a social engineering type threat, a voice phishing type threat, a phishing type threat, a SMS phishing type threat, and a voice altering attack type threat.

At step S410, the security risk analysis device 302 may flag the communication as a potential threat when at least one from among the customer risk score and the representative risk score exceeds a threshold. In some embodiments, the flagged communication may be transmitted to the appropriate personnel, agent, or business unit for at least one from among analysis, training, preventative and/or resolution measures. In an embodiment, the security risk analysis device 302 may be configured to generate a current risk status and recommendation for a next action, based on the flagging and the analysis of the communication. The risk status and recommendation may be transmitted to the representative. For example, the security risk analysis device 302 may flag the communication as being a potential threat, assign the risk level as being high, and transmit a message to the representative recommending that they end the communication or transfer it to their superior.

Then, at step S412, the security risk analysis device 302 may generate suggestions for a response to be provided to the customer based on the analysis of the communication. In an embodiment, the security risk analysis device 302 may provide suggested responses for the entity representative to provide to the customer's queries, in real time. In an embodiment, the security risk analysis device 302 may generate a replica of a voice of the representative and automatically respond to the customer via the generated replica. The security risk analysis device 302 may also be configured to terminate the communication when a risk score exceeds a certain level. Additionally, the security risk analysis device 302 may be configured to generate an automated warning to contact a leadership group of the representative for real-time intervention. In some embodiments, the security risk analysis device 302 may remove the representative from the communication when at least one of the risk scores is determined to be designated as a red threat level. The security risk analysis device 302 may then automatically generate and transmit responses to the customer or assign a new representative to the communication. In an embodiment, the security risk analysis device 302 may be configured to transmit the communication information, the first risk score, and the second risk score to a security entity (e.g., a security operations centers (SOC)) for at least one from among a security investigation and a risk remediation.

According to an embodiment, the security risk analysis device 302 may include an artificial intelligence (AI) cyber security solution that detects social engineering, vishing, phishing, smishing, and voice altering attacks on technical call centers using both traditional methods and newer AI tools. The security risk analysis device 302 may use ML algorithms to analyze calls in real-time, as well as identify patterns and anomalies that may indicate a social engineering attack. It may also detect voice altering technology, flagging calls where the caller's voice has been modified.

In some embodiments, the security risk analysis device 302 may incorporate NLP technology, enabling it to understand the context and intent of the caller's conversation. This may allow it to identify suspicious behavior, such as a caller asking for sensitive information or attempting to bypass security measures. Overall, the security risk analysis device 302 may provide technical call centers with a powerful tool for detecting and preventing social engineering attacks. By combining traditional methods with newer AI tools, it may provide a comprehensive defense against these types of attacks, helping call centers to protect their customers and their business.

The security risk analysis device 302 may detect social engineering, vishing, phishing, smishing, and voice altering attacks on technical call centers. It may use traditional methods and newer AI tools to detect and prevent threats. The security risk analysis device 302 may use ML algorithms to analyze call center data and identify patterns of suspicious behavior. It may also analyze caller voice patterns to detect voice altering attacks. The security risk analysis device 302 may also monitor social media and other online platforms to detect threats. The security risk analysis device 302 may be more accurate and efficient than traditional methods. It may detect threats in real-time and provide alerts to call center agents and supervisors. It may also adapt to evolving threats, making it a more effective solution for call centers.

Examples of AI based tools that may be used by the security risk analysis device 302 for cybersecurity threat detection and prevention. 1) Machine Learning: ML algorithms may analyze large amounts of data to identify patterns and anomalies that may indicate a cybersecurity threat. For example, ML may be used to analyze call center conversations for suspicious keywords or phrases that may indicate a phishing attempt. 2) Natural Language Processing: NLP algorithms may be used to analyze the content of call center conversations to identify potential cybersecurity threats. For example, NLP may be used to detect voice altering attacks or to identify callers who are trying to impersonate legitimate customers. 3) Behavioral Analytics: behavioral analytics may be used to monitor user behavior and detect anomalies that may indicate a cybersecurity threat. For example, behavioral analytics may be used to detect suspicious login attempts or unusual call center activity. 4) Digital Honeypot Call Centers: digital honeypot call centers may use AI to replicate a live agent's voice for interacting with an individual or entity (e.g., a suspicious person and/or user identified as posing a potential cybersecurity threat).

The security risk analysis device 302 may analyze call center conversations in real-time using ML and NLP algorithms to identify suspicious activity. For example, if a caller is attempting to impersonate a legitimate customer, the system may flag the call and alert the call center agent to take appropriate action. The system may also analyze the content of the conversation for suspicious keywords or phrases that may indicate a phishing attempt. In addition, the system may use behavioral analytics to monitor call center activity and detect anomalies that may indicate a cybersecurity threat. For example, if a call center agent suddenly starts accessing sensitive customer information without a legitimate reason, the system may flag the activity and alert security personnel to investigate further. Overall, the security risk analysis device 302 may greatly enhance the accuracy and speed of cybersecurity threat detection and prevention in technical call centers. By using these tools, call centers can better protect sensitive customer information and prevent cybercriminals from gaining access to valuable data.

In an embodiment, the security risk analysis device 302 may implement AI tools including ML algorithms, NLP, and deep learning neural networks. These tools may allow the system to analyze large amounts of data and identify patterns and anomalies that may indicate a cybersecurity threat. The system can then take action to prevent the threat from causing harm to the call center or its customers.

The security risk analysis device 302 may incorporate scalable features that make it effective at detecting and preventing cybersecurity threats in technical call centers: Social Engineering Detection: the system may detect social engineering attempts by analyzing the language and tone of the caller. This may help prevent attackers from tricking call center employees into divulging sensitive information. Vishing Detection: the system may detect voice phishing (vishing) attempts by analyzing the caller's voice and comparing it to known vishing patterns. This may help prevent attackers from using voice manipulation techniques to gain access to sensitive information. Phishing Detection: the system may detect phishing attempts by analyzing the content of emails or other communications and comparing it to known phishing patterns. This may help prevent attackers from tricking call center employees into clicking on malicious links or downloading malware. Smishing Detection: the system may detect SMS phishing (smishing) attempts by analyzing the content of text messages and comparing it to known smishing patterns. This may help prevent attackers from tricking call center employees into divulging sensitive information. Voice Altering Attack Detection: the system may detect voice altering attacks by analyzing the caller's voice and comparing it to known voice altering patterns. This may help prevent attackers from using voice manipulation techniques to gain access to sensitive information.

The security risk analysis device 302 may improve call center security and reduce the risk of cyber-attacks in several ways: Improved Threat Detection: the system may detect cybersecurity threats more quickly and accurately than traditional methods, reducing the risk of data breaches or other cyber-attacks; Reduced False Positives: the system may reduce the number of false positives generated by traditional cybersecurity tools, allowing call center employees to focus on legitimate threats; Increased Efficiency: the system may analyze large amounts of data quickly and efficiently, freeing up call center employees to focus on other tasks; Enhanced Customer Confidence: by improving call center security, the system may enhance customer confidence in the organization's ability to protect their sensitive information; Scale, Concurrency, and Real-time. Overall, the security risk analysis device 302 represents a significant improvement over traditional methods for detecting and preventing cybersecurity threats in technical call centers. Its combination of traditional methods and newer AI tools makes it a powerful tool for protecting sensitive information and preventing cyber-attacks.

The implementation and integration of the security risk analysis device 302 in technical call centers can be a complex process that requires careful planning and execution. The following steps may guide the implementation and integration process: 1) Assess the Existing Infrastructure: before implementing the security risk analysis device 302, it is important to assess the existing infrastructure of the call center. This includes evaluating the hardware and software requirements, network capabilities, and any potential compatibility issues. 2) Identify the Key Features and Functionalities: once the infrastructure assessment is complete, the next step is to identify the key features and functionalities of the security risk analysis device 302. This includes understanding how the solution detects social engineering, Vishing, Phishing, Smishing, and voice altering attacks. 3) Configure the Security Risk Analysis Device: after identifying the key features and functionalities, the next step is to configure the security risk analysis device 302 to meet the specific needs of the call center. This includes setting up the security risk analysis device 302 to work with the existing call center software and hardware. 4) Train Call Center Agents: to use the security risk analysis device 302 effectively, call center agents need to be trained on how to use the solution. This includes understanding how the solution works and how to interpret the results. 5) Monitor and Evaluate the Security Risk Analysis Device: once the security risk analysis device 302 is implemented and integrated, it is important to monitor and evaluate its performance. This includes tracking the number of detected attacks and assessing the accuracy of the solution.

Training call center agents to use the security risk analysis device 302 effectively is crucial for the success of the implementation and integration process. The following steps may guide the training process: 1) Provide an Overview of the Device: call center agents may be provided with an overview of the security risk analysis device 302, including its key features and functionalities. 2) Explain How the Device Works: call center agents may be given a detailed explanation of how the security risk analysis device 302 works, including how it detects social engineering, Vishing, Phishing, Smishing, and voice altering attacks. 3) Demonstrate the Device: call center agents may be given a demonstration of the security risk analysis device 302 in action. This can help them understand how to interpret the results and respond appropriately. 4) Provide Hands-On Training: call center agents should be given hands-on training with the security risk analysis device 302. This can help them gain practical experience and build confidence in using the solution. 5) Offer Ongoing Support: ongoing support may be provided to call center agents to ensure they can effectively use the security risk analysis device 302. This can include providing access to training materials and offering additional training sessions as needed.

The security risk analysis device 302 may detect various types of social engineering attacks on technical call centers. The device may use traditional methods as well as newer AI tools to identify and prevent the following types of attacks: Vishing: this is a type of social engineering attack where the attacker uses voice communication to trick the victim into providing sensitive information or performing an action that is not in their best interest; Phishing: this is a type of attack where the attacker sends an email or other electronic communication that appears to be from a reputable source but is designed to trick the victim into providing sensitive information or performing an action that is not in their best interest; Smishing: this is a type of attack where the attacker uses SMS messaging to trick the victim into providing sensitive information or performing an action that is not in their best interest; Voice Altering: this is a type of attack where the attacker uses technology to alter their voice to impersonate someone else and trick the victim into providing sensitive information or performing an action that is not in their best interest. The security risk analysis device 302 may detect these types of attacks by analyzing various factors, including the content of the communication, the tone of voice, and other behavioral patterns. The security risk analysis device 302 may also be able to learn and adapt over time, which makes it more effective at detecting new and emerging types of attacks. Overall, the security risk analysis device 302 may be an effective and reliable tool for protecting technical call centers from social engineering attacks. By leveraging traditional methods and newer AI tools, the security risk analysis device 302 can provide a high level of security and peace of mind for call center operators and their customers.

In an embodiment, the security risk analysis device 302 may include the following components: 1) Data Collection Component: this component may be responsible for collecting data from various sources, including call center logs, voice recordings, and customer feedback. The data collected may be used to train the AI models and improve the accuracy of the detection system. 2) AI Model Training Component: this component may be responsible for training the AI models used in the solution. The models may be trained using ML algorithms on the data collected from the Data Collection Component. The models may be trained to detect patterns and anomalies that indicate social engineering attacks. 3) AI Model Validation Component: this component may be responsible for validating the accuracy and effectiveness of the AI models used in the solution. The validation process may involve testing the models on a separate set of data to ensure that they can accurately detect social engineering attacks. 4) Detection and Alerting Component: This component may be responsible for detecting social engineering attacks and alerting the relevant personnel in the call center. The component may use the AI models to analyze voice recordings and call center logs in real-time to detect any suspicious activity. Once an attack is detected, an alert may be sent to the relevant personnel to take appropriate action. 5) Reporting and Analytics Component: this component is responsible for generating reports and analytics on the social engineering attacks detected by the security risk analysis device 302. The reports may be used to identify trends, patterns, and common attack vectors. This information can be used to improve the overall security posture of the call center and prevent future attacks. Overall, these architectural components may provide a comprehensive solution for detecting social engineering attacks on technical call centers. The combination of traditional methods and newer AI tools ensures that the solution is accurate and effective in detecting these types of attacks.

In some embodiments, the security risk analysis device 302 may also include the following components: 1) Data Collection: the security risk analysis device 302 may collect data from various sources including call recordings, chatlogs, and social media feeds. This data may be used to train the AI models and to identify patterns and anomalies that may indicate a cyber-attack. 2) AI Models: the security risk analysis device 302 may use a combination of supervised and unsupervised learning models to analyze the collected data. The supervised models are trained to detect known attack patterns, while the unsupervised models are used to identify new and emerging threats. 3) Threat Intelligence: the security risk analysis device 302 may also incorporate threat intelligence feeds to augment the AI models. This includes information on known threat actors, their tactics, techniques, and procedures (TTPs), and other relevant information. 4) Real-Time Detection: the AI models may be deployed in real-time to analyze incoming calls and chats. If an attack is detected, an alert may be generated and sent to the appropriate security personnel for further investigation. 5) Reporting: the solution may also include reporting capabilities to provide insights into the overall security posture of the call center. This may include metrics such as the number of attacks detected, the types of attacks, and the effectiveness of the AI models.

Each of the above listed components may provide a series of benefits including: 1) Improved Detection: the security risk analysis device 302 may provide improved detection capabilities for social engineering, Vishing, Phishing, Smishing, and voice altering attacks. The security risk analysis device 302 may use a combination of traditional methods and newer AI tools to provide a comprehensive approach to cyber security. 2) Real-Time Detection: the security risk analysis device 302 may provide real-time detection capabilities, which allows security personnel to quickly respond to any detected attacks. 3) Automated Response: the security risk analysis device 302 may be configured to automatically respond to detected attacks, which can help to mitigate the impact of the attack. 4) Improved Reporting: the security risk analysis device 302 may provide improved reporting capabilities, which allows for better analysis of the overall security posture of the call center. 5) Reduced Costs: the security risk analysis device 302 may help to reduce costs associated with cyber-attacks, such as lost revenue and reputational damage.

In an embodiment, the security risk analysis device 302 may shadow all calls, interpret all voice traffic on-the-fly, identify social engineering, remember bad actors, rate live agents, constantly audit calls, and educate live agents in real time. Additionally, the security risk analysis device 302 may have the ability to cut calls or send calls to a Human Honey Pot, or a Digital Honey Pot depending on the level of perceived risk.

Accordingly, with this technology, an optimized process for analyzing communications to determine a probability of a potential security threat to an entity and automatically generating responses to reduce the potential security threat is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for assessing a likelihood of a security risk, the method being implemented by at least one processor, the method comprising:
receiving, by the at least one processor, first information that relates to a communication between a representative of an entity and a customer;
determining, by the at least one processor from the first information, at least one communication attribute that is based on at least one from among a content of the communication, a tone of voice used in the communication, language used in the communication, a behavioral pattern of the customer in the communication, and a behavioral pattern of the representative in the communication;
determining, by the at least one processor based on the at least one communication attribute, a first risk score that relates to the customer; and
determining, by the at least one processor based on the at least one communication attribute, a second risk score that relates to the representative,
wherein each of the first risk score and the second risk score relates to a probability of a potential security threat to the entity.

2. The method of claim 1, further comprising:
generating, by the at least one processor based on the analyzing of the first information, suggestions for at least one response to be provided to the customer; and
wherein the analyzing of the first information includes at least one from among a point-in-time assessment, a real-time assessment, and a continuous assessment of the at least one communication attribute.

3. The method of claim 1, further comprising:
flagging the communication as a potential threat when at least one from among the first risk score and the second risk score exceeds a predetermined threshold score;
generating, by the at least one processor based on the flagging of the communication and the analyzing of the first information, a current risk status and a recommendation for at least one next action; and
transmitting, by the at least one processor, the current risk status and the recommendation to the representative.

4. The method of claim 1, wherein the analyzing of the first information comprises applying a natural language processing (NLP) model to identify a context and an intent of the communication.

5. The method of claim 1, wherein the communication includes a telephone call, wherein the analyzing of the first information comprises applying a machine learning (ML) algorithm that performs at least one from among identifying at least one from among a pattern and an anomaly in the telephone call and detecting a use of a voice altering technology, wherein the ML algorithm is trained using enterprise risk guidelines, and wherein the ML algorithm applies the enterprise risk guidelines for the assessing of the at least one communication attribute.

6. The method of claim 5, further comprising:
collecting at least one from among call recordings, call center logs, voice recordings, customer feedback, chat logs, and social media feeds; and
training, based on the collecting, the ML algorithm to detect conversational patterns and conversational anomalies that are usable for determining at least one from among the first risk score and the second risk score.

7. The method of claim 1, further comprising:
when at least one from among the first risk score and the second risk score exceeds a predetermined threshold, performing at least one from among:
generating, by the at least one processor, a replica of a voice of the representative and automatically responding to the customer via the generated replica;
terminating, by the at least one processor, the communication; and
generating, by the at least one processor, an automated warning to contact a leadership group of the representative for real-time intervention.

8. The method of claim 1, further comprising:
analyzing, by the at least one processor, first screening data that relates to the customer, wherein the first screening data includes at least one from among a caller identification assessment of the customer, a telephone number assessment of the customer, and a voice assessment of the customer;
assigning, by the at least one processor based on the analyzing of the first screening data, a first screening score to the customer; and
matching, by the at least one processor based on the first screening score, the customer to a corresponding entity representative selected from among a plurality of entity representatives.

9. The method of claim 1, further comprising:
transmitting, by the at least one processor, the first information, the first risk score, and the second risk score to a security entity for at least one from among a security investigation and a risk remediation; and
wherein the potential security threat to the entity includes at least one from among a social engineering type threat, a voice phishing type threat, a phishing type threat, a short message service (SMS) phishing type threat, and a voice altering attack type threat.

10. A computing apparatus for assessing a likelihood of a security risk, the computing apparatus comprising:
a processor;
a memory; and
a communication interface coupled to each of the processor and the memory,
wherein the processor is configured to:
receive first information that relates to a communication between a representative of an entity and a customer;
determine, from the first information, at least one communication attribute that is based on at least one from among a content of the communication, a tone of voice used in the communication, language used in the communication, a behavioral pattern of the customer in the communication, and a behavioral pattern of the representative in the communication;
determine, based on the at least one communication attribute, a first risk score that relates to the customer; and
determine, based on the at least one communication attribute, a second risk score that relates to the representative,
wherein each of the first risk score and the second risk score relates to a probability of a potential security threat to the entity.

11. The computing apparatus of claim 10, wherein the processor is further configured to:
generate, based on the analysis of the first information, suggestions for at least one response to be provided to the customer; and
wherein the analysis of the first information includes at least one from among a point in time assessment, a real-time assessment, and a continuous assessment of the at least one communication attribute.

12. The computing apparatus of claim 10, wherein the processor is further configured to:
flag the communication as a potential threat when at least one from among the first risk score and the second risk score exceeds a predetermined threshold score;
generate, based on the flagging of the communication and the analyzing of the first information, a current risk status and a recommendation for at least one next action; and
transmit, via the communication interface, the current risk status and the recommendation to the representative.

13. The computing apparatus of claim 10, wherein the processor is further configured to:
apply a natural language processing (NLP) model to identify a context and an intent of the communication.

14. The computing apparatus of claim 10, wherein the communication includes a telephone call,
wherein the processor is further configured to:
apply a machine learning (ML) algorithm that performs at least one from among identifying at least one from among a pattern and an anomaly in the telephone call and detecting a use of a voice altering technology, wherein the ML algorithm is trained using enterprise risk guidelines, and wherein the ML algorithm applies the enterprise risk guidelines for the assessing of the at least one communication attribute.

15. The computing apparatus of claim 14, wherein the processor is further configured to:
collect at least one from among call recordings, call center logs, voice recordings, customer feedback, chat logs, and social media feeds; and
train, based on the collection, the ML algorithm to detect conversational patterns and conversational anomalies that are usable for determining at least one from among the first risk score and the second risk score.

16. The computing apparatus of claim 10, wherein the processor is further configured to:
when at least one from among the first risk score and the second risk score exceeds a predetermined threshold, perform at least one from among:
generate a replica of a voice of the representative and automatically respond to the customer via the generated replica;
terminate the communication; and
generate an automated warning to contact a leadership group of the representative for real-time intervention.

17. The computing apparatus of claim 10, wherein the processor is further configured to:
analyze first screening data that relates to the customer, wherein the first screening data includes at least one from among a caller identification assessment of the customer, a telephone number assessment of the customer, and a voice assessment of the customer;
assign, based on the analysis of the first screening data, a first screening score to the customer; and
match, based on the first screening score, the customer to a corresponding entity representative selected from among a plurality of entity representatives.

18. The computing apparatus of claim 10, further comprising:
transmit, via the communication interface, the first information, the first risk score, and the second risk score to a security entity for at least one from among a security investigation and a risk remediation; and wherein the potential security threat to the entity includes at least one from among a social engineering type threat, a voice phishing type threat, a phishing type threat, a short message service (SMS) phishing type threat, and a voice altering attack type threat.

19. A non-transitory computer readable storage medium storing instructions for assessing a likelihood of a security risk, the storage medium comprising executable code which, when executed by a processor, causes the processor to:
receive first information that relates to a communication between a representative of an entity and a customer;
determine, from the first information, at least one communication attribute that is based on at least one from among a content of the communication, a tone of voice used in the communication, language used in the communication, a behavioral pattern of the customer in the communication, and a behavioral pattern of the representative in the communication;
determine, based on the at least one communication attribute, a first risk score that relates to the customer; and
determine, based on the at least one communication attribute, a second risk score that relates to the representative,
wherein each of the first risk score and the second risk score relates to a probability of a potential security threat to the entity.

20. The storage medium of claim 19, wherein when executed by the processor, the executable code further causes the processor to:
generate, based on the analysis of the first information, suggestions for at least one response to be provided to the customer; and
wherein the analysis of the first information includes at least one from among a point in time assessment, a real-time assessment, and a continuous assessment of the at least one communication attribute.
